(19) United States
(12) Patent Application Publication
(10) Pub. No.: US 2006/0023872 A1
(43) Pub. Date: Feb. 2, 2006

(54) Portable electronic device customization kit

(76) Inventor: Richard Chang, Chula Vista, CA (US)

Correspondence Address: GEORGE S. LEVY, 3980 DEL MAR MEADOWS, SAN DIEGO, CA, 92130, US

(21) Appl. No.: 11/184,319

(22) Filed: Jul. 19, 2005

Related U.S. Application Data
(60) Provisional application No. 60/591,747, filed on Jul. 28, 2004.

(51) Int. Cl. H04M 1/00; H04M 9/00

(52) U.S. Cl. 379/440

(57) ABSTRACT

A kit for personalizing a portable electronic device and for protecting it from scratches. This kit comprises several decal sheets each one comprising in a sandwich, a) a decorative layer, having a top side and a bottom side, the top side displaying decorative or artistic patterns, and the bottom side coated with a strong adhesive; b) a waxy layer applied to the bottom side of the decorative layer and covering the strong adhesive. Each decal sheet is cut to fit an area of the electronic device such as not to cover the electronic device's functional parts. Just prior application of decal sheets to the electronic device the waxy layer is removed from the decal sheets.

This invention claims the benefit of U.S. Provisional Application No. 60/591747 with the title, “Cell Phone Customization Kit and Method of Fabrication” filed on Jul. 28^{th} 2004 and which is hereby incorporated by reference. Applicant claims priority pursuant to 35 U.S.C. Par 119(e)(i). This invention relates to a kit for customizing or personalizing an electronic device such as a cellular phone., as well as protecting it from scratches. This kit can be used by a user after he or she has acquired possession of the electronic device. This invention also relates to the method of manufacture of this kit.

### FIELD OF THE INVENTION

### BACKGROUND

Electronic devices such as cell phones are available in a variety of models. Each model is offered with a choice of casings of different colors and patterns. These choices. however, are limited. In addition, electronic merchants in particular cell phone merchants charge a high price for such options. There is a need for an inexpensive means for users to customize or personalize their personal electronic device.

Cell phones are easily scratched. There is a need for a simple method for covering these scratches and/or protecting cell phone from scratches.

There is also a need for a customization method that could be employed by a cell phone owner to personalize his own phone.

In U.S. Pat. No. 6,504,928 by Toyooka, a method of decorating a cellular phone is described by means of a foil-decorating film. This method however must be employed at the factory where the cell phone casing is made and is not appropriate to be used by the end user of the cell phone. Toyooka teaches that the decorative layers must have an uppermost transparent base film layer, a symbol layer for displaying at least one of a character and a symbol, a hiding layer, and a transparent adhesive layer, said symbol layer and said hiding layer being laminated onto said base film layer, and said adhesive layer being laminated onto said base film layer, said symbol layer, and said hiding layer.

In addition Toyooka relies on lamination and injection molding processes which are appropriate in a manufacturing environment but are unavailable to a phone user.

In contrast, this invention offers a cell phone user, in a kit form, the tools for customizing his phone. In this invention, the uppermost layer does not have to be transparent, and there is no need for a symbol layer and for a hiding layer. In addition, the method of application of the decorative and protective layer in this invention is very different from the one used by Toyooka. It is a simple decal process that most cell phone users can easily implement.

It is therefore an object of this invention to provide an inexpensive means for users to customize, personalize, or individualize their electronic device such as their cell phones or I-Pods™.

It is another object of this invention to provide an inexpensive means for users to hide existing scratches on their electronic device and/or to protect them against further scratches.

### SUMMARY OF THE INVENTION

The present invention relates to a method of customizing or personalizing electronic devices such as cell phones, while protecting them from scratches or hiding existing scratches. It comprises one or several decals specifically designed to fit the contour of an electronic device and cut with holes to allow easy access to functional parts of the device such as buttons, display, microphone and electrical ports. While the preferred embodiment for this invention is a kit designed to personalize and protect a cell phone, the same technology can be used for a wide range of other electronic devices as shall be apparent.

Further features, aspects, and advantages of the present invention will be more fully understood when considered with respect to the following detailed description claims and accompanying drawings.

### BRIEF DESCRIPTION OF THE DRAWINGS

FIG. 1 illustrates the decal for the inside top half of a cellular phone.

FIG. 2 shows the decal for the inside bottom half of a cellular phone.

FIG. 3 describes the decal for the outside top half of a cellular phone.

FIG. 4 illustrates the decal for the outside bottom half of a cellular phone.

### DETAILED DESCRIPTION OF DRAWINGS

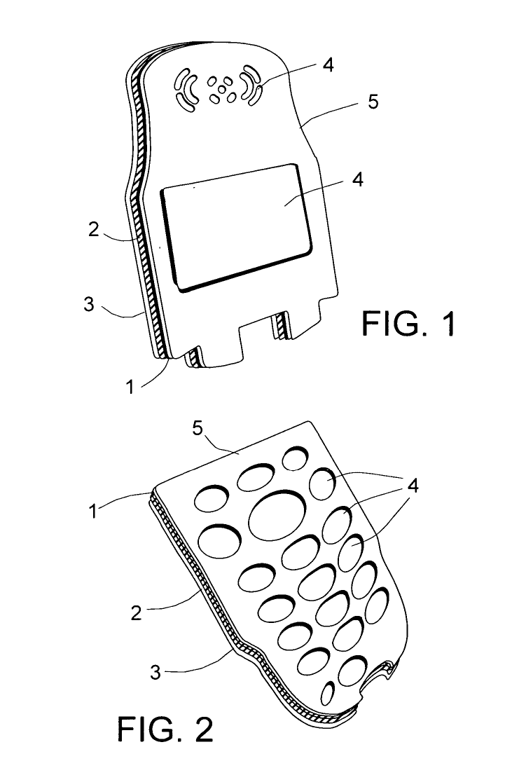

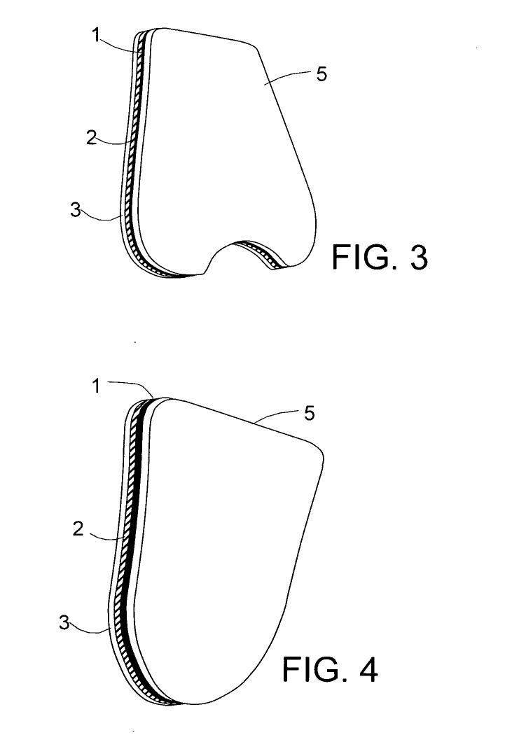

A preferred embodiment of this invention is shown in FIGS. 1 through 4. It consists of one or several pieces of decorative and protective sheets. Each piece is cut appropriately to fit different areas of a portable electronic device such as a cellular phone's casing. The example shown in the figures are decals that can be applied to the Motorola i60 phone which is foldable. The top half carries the display and the loudspeaker and the bottom half carries the controls and the microphone. Of course, depending on the phone model, the shape of the cutouts will be different. FIG. 1 describes the cutout for the top inside half of the phone that carries the display and the loudspeaker. FIG. 2 shows the cutout for the bottom inside half of the phone that carries the controls and the microphone. FIG. 3 describes the cutout for the top outside half of the phone behind the display. FIG. 4 illustrates the cutout for the bottom outside half of the phone behind the controls. The pieces of sheet typically carry a decorative pattern 1 on one of their sides. They are coated on the other side 2 with an adhesive to allow them to be easily affixed to the cellular phone casing. This adhesive side is shielded by means of a waxy backing 3 which is easily removed just prior to application. Holes 4 are cut in the pieces of decorative and protective sheet to allow unencumbered access to some of the parts of the cell phone such as the keyboard's buttons, the display, the microphone, the speaker, the ear phone port, status lights, joining parts such as hinges, the camera lens for those cell phones that are integrated with a digital camera, the antenna and logos. The result is a decal which can be applied to a cell phone for the purpose of customization or personalization or to protect the cell phone against scratches or to hide existing scratches.

Many variations to this basic design are possible. There exists a wide diversity of such decorative/protective sheets. They could be made of vinyl or any convenient plastic. The plastic could be transparent or opaque and the pattern could be in silver, gold, or colored, and could include holograms. The plastic should be tough enough to provide some protection against scratches. The decorative layer could be printed by offset (for example in 4 colors) or by digital printing. It could be made of Mylar™ and display holograms or can be printed by conventional means. In addition, the top layer 1 could be laminated with a clear transparent layer 5 such as vinyl or polyester to provide additional protection.

As mentioned above, the figures describe specific decals configured for the Motorola i60 cell phone. These decals are just an example for a particular cell phone and it is clear that the same approach can be used for a wide diversity of cell phones. For example decals have been fabricated for other cell phone models such as the Nextel i60, i90, i95, i205, i530 and i730. Decals have also been made for the Motorola C200, C333, T720 and V600; for the GD55 from Panasonic; and for the VX6000 from LG. It is clear that this technique of personalizing a cell phone and protecting it from scratches can be extended to a video cell phone or a GPS phone or any present or future communication device.

Manufacturing of the Kit

Several methods can be used to manufacture such decals. For low volume production a plotter/cutter machine such as the model CE2800 made by Graphtec could be used. When Such a machine is employed, manufacturing of this customization kit includes the following steps:
1) For any given cellular phone for which a customization kit needs to be generated, use a scanner or camera to generate an image of each side of the cellular phone to be covered.
2) Import the images into a graphic design program such as Coreldraw.
3) Using the drawing tools from the design program, trace out the images following the contours and necessary holes for items such that buttons, speaker, windows, microphone, logo, and electrical port. Arrange the layout of the images such that they all fit a single sheet.
4) Load plotter/cutter with decorative/protective adhesive sheets or film. Typically, one side of this sheet is decorative and the other side is coated with adhesive and covered with a waxy paper.
5) Send the trace to the plotter/cutter and initiate the “cut” command.
6) Retrieve the adhesive sheet or film from the plotter/cutter. Optionally unwanted plastic or vinyl cut-outs could be removed or left in place to be removed later by the user of the kit (the person who performs the application of the decal onto his phone.)
7) Cover the decorative side of the adhesive sheet with a piece of adhesive transparent transfer tape. The purpose of this tape is to hold the adhesive sheet together when it is applied to the cell phone.
8) Cut the adhesive sheet/transfer tape sandwich into sections, each section holding a separate applique.

Another method of generating these decals that may be more economical in large production runs involves cutting the adhesive plastic sheet using a die-cutting technique. Typically a cutting die is fabricated according to the desired cutting shape. The die may be designed to generate punch-through cuts or kissing cuts. Punch through cuts are suitable for the complete removal of pieces from the decal while kissing cuts are suitable for cutting the surface of the decal while leaving intact the substrate suitable for holding the decal together. Typically punch through cuts are used to make holes for buttons and displays and kissing cuts are used around the edge of the decal. After the adhesive sheet is cut, steps 7 and 8 as described above can be used to produce the applique.

Utilization of the Kit.

To use the kit, the consumer should follow these steps:
1) If the surface of the cell phone is not clean, it should be cleaned with a gentle solvent that does not damage its surface, such as alcohol, and then be allowed to dry thoroughly.
2) The user starts with the decal sandwich comprising a) the transfer tape, b) the decorative and protective decals which are on one side being supported by the transfer tape, and on the other side carrying an adhesive, c) a waxy backing that shields the adhesive. He must then find a point of reference on the phone to line up the decal with the phone. Such point of reference could be a button or a logo for example. The user then applies the decal starting at the point of reference and moving outward to avoid air trapping.
3) The user must then rub the decal evenly from one side to the other to assure that it is properly adhering to the cell phone.
4) The user must then gently separate the transfer tape from the decal. Since the bond between the transfer tape and the decal is much weaker than the one between the decal and the phone, this task is relatively easy.
5) The must then repeat steps I through 4 for the other pieces.

Applications.

This invention could be applied to enhance the appearance of a multitude of personal portable electrical and electronic devices such but not limited to cell phones, palm-top computers, personal assistant devices such as Blackberries™, and entertainment devices such as I-Pods™. The invention could also be used to customize and personalize automotive dashboard, stereo and video equipment and even electrical appliances.

While the above description contains many specificities, the reader should not construe these as limitations on the scope of the inventions but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

What is claimed is

1) a kit for personalizing a portable electronic device and for protecting it from scratches comprising several decal sheets, each said decal sheet comprising in a sandwich:
a) a decorative layer having a top side and a bottom side, said top side displaying decorative or artistic patterns, and said bottom side coated with a strong adhesive; and
b) a waxy layer applied to said bottom side of said decorative layer, covering, said strong adhesive,
wherein each said decal sheet is cut to fit an area of said electronic device such as not to cover the electronic device's functional parts,
whereby, just prior application of said decal sheets to said electronic device said waxy layer is removed from said decal sheets.

2) A kit as in claim 1 wherein said decorative layer is coated on its top side with a transparent lamination layer, thereby providing additional protection to, and unobstructed visibility of, said decorative substrate layer after said decal is applied.

3) A kit as in claim 2 wherein said top side of said lamination layer is covered by, and weakly adhesively bonded to, a transfer tape, whereby said transfer tape facilitates the application of said decal to said electronic device and is removed after its application.

4) A kit as in claim 1 wherein said top side of said decorative layer is covered by, and weakly adhesively bonded to, a transfer tape, whereby said transfer tape facilitates the application of said decal to said electronic device and is removed after its application.

5) A kit as in claim 1 wherein said decorative substrate layer comprises holograms.

6) A kit as in claim 1 wherein said decorative substrate layer contains printed patterns, images or photographs.

7) A kit as in claim 1 manufactured by means of a plotting and cutting machine.

8) A kit as in claim 1 manufactured by means of a die cutting technique.

9) A kit as in claim 1 manufactured by means of a die cutting machine that performs punch-through cuts and kissing cuts.

10) A kit as in claim 1 wherein said electronic device is a cell phone.

11) A kit as in claim 1 wherein said electronic device is a palm-top computer.

12) A kit as in claim 1 wherein said electronic device is a personal assistant device.

13) A kit as in claim 1 wherein said electronic device is an electronic entertainment device.

14) A kit as in claim 1 wherein said electronic device is an electronic musical player.

15) A kit as in claim 1 wherein said electrical device is home electrical appliance.

16) A kit as in claim 1 wherein said electrical device is home stereo equipment.

17) A kit as in claim 1 wherein said electrical device is home video equipment.
